(19) United States
(12) Patent Application Publication
(10) Pub. No.: US 2019/0065547 A1
(43) Pub. Date: Feb. 28, 2019

(54) TRANSACTIONAL MULTI-DOMAIN QUERY INTEGRATION

(71) Applicant: CA, Inc., New York, NY (US)

(72) Inventors: Yang Yang, Newton, MA (US); Lin Xiao, Stratham, NH (US)

(21) Appl. No.: 15/691,386

(22) Filed: Aug. 30, 2017

(51) Int. Cl. G06F 17/30

(52) U.S. Cl. CPC G06F 17/30436; G06F 17/30545; G06F 17/30554

(57) ABSTRACT

Methods, systems, and program products for processing queries in a multi-domain source interface system are disclosed. In some embodiments, in response to a first query request from a source interface tool for performance data stored in a data source, one or more query methods that conform to a native query schema of the data source are retrieved. A second query request that includes the retrieved query methods is generated and transmitted to the data source. Query results received in response to the second query request are transmitted to the source interface tool.

### BACKGROUND

The disclosure generally relates to the field of data processing, and more particularly to providing a unified interface for integrating and interacting with data sources.

Data collection and storage systems utilize a variety of different data storage and organization formats such as may be utilized by different types of databases, file systems, object-based storage paradigms, etc. Multiple of such data collection and storage systems (collectively, data sources) may be accessed by higher-level systems and applications to, for example, provide a unified, centralized data management and query interface for client applications. Such unified management/reporting systems (collectively, source interfaces) include subsystems or employ external systems to implement the requisite syntax translation and/or query schema translation.

### BRIEF DESCRIPTION OF THE DRAWINGS

Embodiments of the disclosure may be better understood by referencing the accompanying drawings.

FIG. 1 is a block diagram depicting subsystems, devices, and components for implementing a data source integration system in accordance with some embodiments;

FIG. 2A is a block diagram illustrating an example data source integration system that includes subsystems, devices, and components for implementing data source integration including multi-domain query processing in accordance with some embodiments;

FIG. 2B illustrates an example sync application program interface (API) as may be implemented by a data source integration system in accordance with some embodiments;

FIG. 2C depicts an example query proxy and normalizer as may be implemented by a data source integration system in accordance with some embodiments;

FIG. 2D depicts a method set file that includes code for implementing multiple query methods in accordance with some embodiments;

FIG. 3 is a flow diagram illustrating operations and functions for integrating data sources with a reporting tool in accordance with some embodiments;

FIG. 4 is a flow diagram depicting operations and functions for processing queries in a multi-domain source interface system in accordance with some embodiments; and

FIG. 5 is a block diagram depicting an example computer system that integrates data sources with a reporting tool including processing multi-domain queries in accordance with some embodiments.

### DESCRIPTION

The description that follows includes example systems, methods, techniques, and program flows that embody embodiments of the disclosure. However, it is understood that this disclosure may be practiced without these specific details. For instance, this disclosure refers to integrating data sources that store computing components and associated performance data in illustrative examples. Aspects of this disclosure can also be applied to other types of data sources in which other types of items are inventoried in association with other types of associated description information. In some instances, well-known instruction instances, protocols, structures and techniques have not been shown in detail in order not to obfuscate the description.

Overview

Systems, method, devices and components are disclosed and described herein for integrating data sources with a centralized/unified source interface. A source interface may comprise a unified reporting tool that is communicatively coupled to multiple, mutually distinct data sources. The reporting tool may include subsystems and components for providing a unified reporting interface for two or more data sources in the form of monitoring systems that collect and store performance data for or otherwise associated with objects or items (collectively referred to as inventory items) information. For example, the data sources may include an application program monitoring system and a hardware device monitoring system that each stores respective inventory data and corresponding performance data using mutually distinct data storage and query formats and schemas. As utilized herein, a data source may be generally characterized as any combination of computing hardware and code forming a module or tool that may collect, process, and store data.

A source interface may include, for example, a web-based portal that may be accessed by corresponding client nodes to retrieve and display data in various visual presentations. The embodiments disclosed herein include integration/mediation features for efficiently organizing inventory data and associated performance data from various different data sources. In some embodiments, an integration logic layer includes subsystems, devices, and components that provide transaction-oriented data source integration. For example, the integration layer may comprises a set of integration packs that each include a combination of programmed components for integrating a respective data source on a per-transaction basis. In some embodiments, one or more integration packs are allocated for each of the two or more distinct data sources.

Two or more of the data sources may each collect and store inventory item information and also collect and store associated operational/performance data. Each of the integration packs allocated to a respective one of such data sources may include a sync API component, a query proxy component, and a normalizer component. The normalizer component may be combined with the query proxy component in some embodiments. As explained in further detail below, for each integration pack the sync API component is configured to perform several tasks such as monitoring a sync communication port through which a source interface tool conducts low-level communications such as registration as well as requesting and processing sync operations. In response to a detected sync request, the sync API includes sync operation code that conforms to the sync protocol and data storage format native to the particularly data source that the sync API's integration pack has been allocated to. In addition to executing the sync operation directly with the data source, the sync API component is further configured to process sync requests by extracting query schema information that is native to the data source.

In addition to a sync API, each integration pack may further include a query proxy component and a normalizer component. The normalizer component may be configured to translate the format of query result data into a common, or “normalized,” format. The query proxy component is configured to monitor a query port on which the source interface sends and processes query requests. As utilized herein, a query request may be generally characterized as including one or more particular queries (referred to herein alternately as “query methods”) and other information such as communication protocol information and other data or metadata. The query requests generated and sent by the source interface may be formatted or otherwise structured to conform to a different query schema that are utilized by one or more of the data sources. In response to a received query request, the query proxy component performs a domain mediation function by generating and transmitting another, distinct query request having query methods that conform to the native query schema of the data source.

In some embodiments, the sync API and query proxy components may be cooperatively configured to efficiently process queries in a multi-domain source data interface environment. The sync API may be configured to extract native query schema information during a sync operation and to return at least some of the extracted query schema information together with the requested sync data to the source interface. For example, the sync API may merge one or more extracted query method identifiers (IDs) with respective ones of multiple inventory items that are the subject of the sync operation and send the merged information to the source interface. The source interface may store the query method IDs and also store the associations of the query method IDs with respective corresponding inventory items. In response to a client query request for performance data of one or more inventory items, the source interface generates and forwards another query request that includes one or more query methods IDs that were stored as part of previous sync operations. The query proxy component receives the forwarded query request and utilizes the query method IDs to locate corresponding locally stored query methods that are native to the data source query schema. The query proxy generates another query that includes the native query methods in place of the queries that were originally included in the client query request received from the source interface.

A data source integration system exposes a flexible and programmable integration framework (integration pack) that intercepts sync requests from a unified source interface. Having customizable proxy workflow, the integration pack generates domain specific sync requests that are passed to the target data source, thereby completing an inventory configuration sync. A domain based query integration system proxies a query request that is directed to a target data source. Using a programmable normalization framework, the query integration system converts a response of any format into normalized, format that clients are configured to process and passes the normalized content back to the source interface. Multiple integration packs and an integration manager form an integration pack ecosystem that is coordinated by the integration manager, which provides high-available and a horizontally scalable integration layer.

Example Illustrations

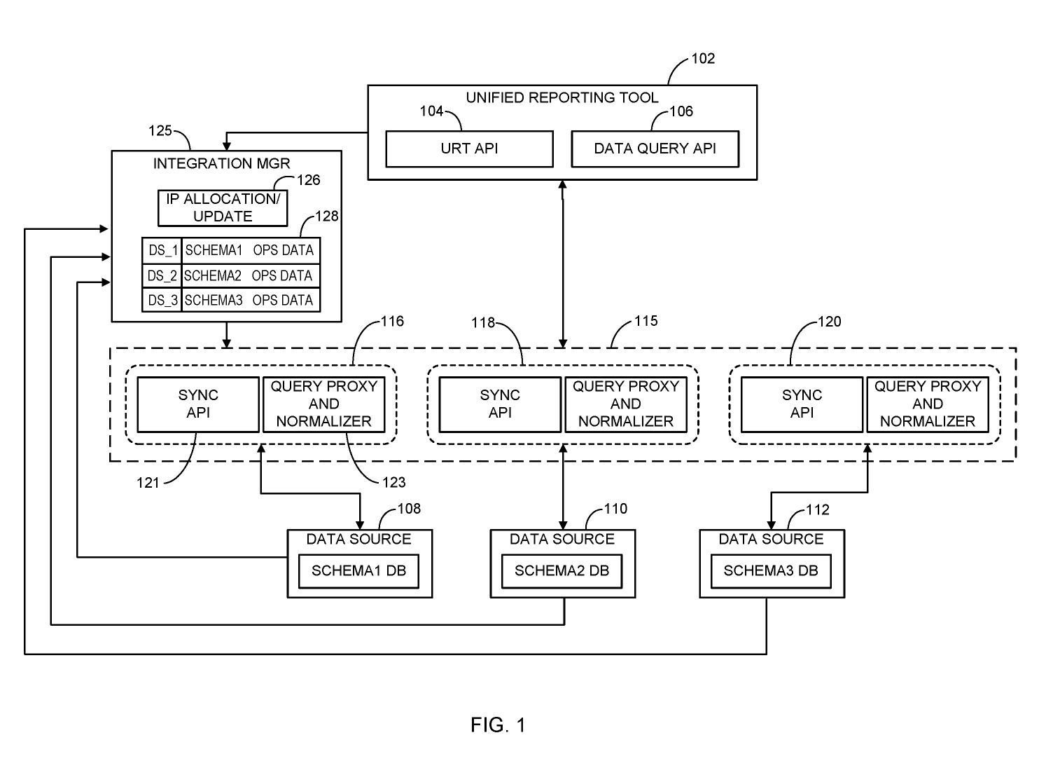

FIG. 1 is a block diagram depicting subsystems, devices, and components for implementing a data source integration system in accordance with some embodiments. As shown in FIG. 1, the system includes a source interface implemented as a unified reporting tool 102 that is communicatively and otherwise logically coupled with data sources 108, 110, and 112 via an integration layer 115. Reporting tool 102 is also communicatively coupled to an integration manager 125 that itself is communicatively coupled to components within integration layer 115 and to data sources 108, 110, and 112.

Reporting tool 102 comprises programmed systems and components including a unified reporting tool (URT) API 104 and a performance data query API 106. URT API 104 and query API 106 each include programmed methods and functions such as may include web services that are called during transactions between reporting tool 102 and other systems or components. URT API 104 includes any combination of program logic and data configured to implement sync operations for inventory information that is collected, stored, and updated by each of data sources 108, 110, and 112. A sync operation may be generally characterized as an information/data synchronization operation that includes processing steps for updating the data in one repository (e.g., target database with at least some stale data) to more closely match the data in another repository (e.g., data source). Query API 106 includes any combination of program logic and data configured to implement query operations at a higher-level than the specific query methods that are ultimately executed to directly obtain performance data from data sources 108, 110, and 112.

Each of data sources 108, 110, and 112 includes multiple program components configured to collect, store, and provide information. For instance, the data sources may each include a collection interface (not expressly depicted) for retrieving information such as configuration information and performance data from a particular performance monitoring domain. In such a context, the configuration information may include identifiers and other descriptive information for a number of computer system entities (alternately referred to as inventory items) such as application programs and/or hardware devices that may be monitored such as by locally installed collection agents. The performance data may comprise operational metrics associated with the monitored computer system entities. For instance, the operational metrics may include operational context information such as percent utilization as well as performance level data such as program/device response metrics.

As illustrated in FIG. 1, each of data sources 108, 110, and 112 further includes a respective native data storage format and native query schema. Each data source is a mutually independent data collection and data storage system. In some embodiments, data sources 108, 110, and 112 may be multiple instances of a same collection and storage system (i.e., different instances of a system sharing a storage format and query schema), or they may be different types of systems having different storage formats and/or query schemas. Since each of the different-type systems or different instances of same-type system instance are synched through different integration packs, each has a different sharding key, which they can utilize to individually identify themselves to the unified reporting tool.

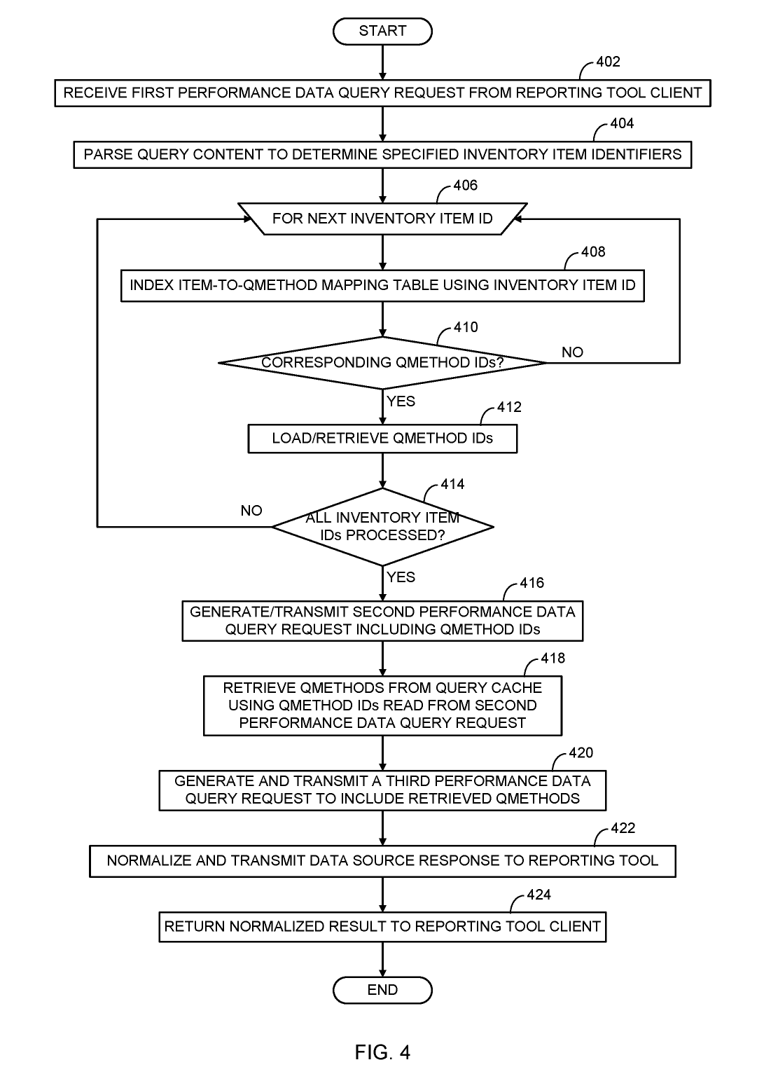

The combined data storage formats and query schemas of data sources 108, 110, and 112 are depicted as SCHEMA1 DB, SCHEMA2 DB, and SCHEMA3 DB. Each of SCHEMA1 DB, SCHEMA2 DB, and SCHEMA3 DB represents a database that, as depicted and described in further detail with reference to FIG. 4A, stores inventory information in tables, records, and other logical structures conforming to a native inventory description format. The depicted database schemas further include a native query schema for accessing and retrieving performance data associated with the inventory items identified and otherwise described by the inventory information.

Integration layer 115 is configured, using any combination of coded software, firmware, and/or hardware, to perform data source integration functions in a manner that at least partially decouples source interface logic (API and application logic of reporting tool 102) and substantially decouples data source logic from the distributed logic implemented by integration layer 115 to perform the requisite mappings and translations. Integration functions performed by integration layer 115 include domain query integration as well as overall data source inventory/query integration for data sources 108, 110, and 112. In some embodiments, integration layer 115 includes and/or is implemented by a hardware and software processing and communications platform such as may be implemented by one or more servers that communicate with the data sources and reporting tool 102 via network connections.

Executing within integration layer 115 are a set of integration packs 116, 118, and 120. Each of integration packs 116, 118, and 120 are allocated by integration manager 125 to reporting tool 102 as well as to a respective one of the data sources. As schematically depicted in FIG. 1, integration packs 116, 118, and 120 are individually allocated to data sources 108, 110, and 112, respectively. Each of the integration packs includes a sync API, such as sync API 121 within integration pack 108, and a query proxy and normalizer, such as query proxy and normalizer 123.

Each sync API is configured to process sync requests from URT API 104 directed to a particular data source. For example, in response to a sync request from URT API 104, sync API 121 executes a mediated sync operation beginning by generating an intermediate sync request and sending the request to data source 108. In its mediation function, sync API 121 effectively replaces the unified sync request format that the initial request from URT API 104 conforms to with the intermediate request that conforms to the native inventory description format of data source 108 (e.g., inventory description format specified by SCHEMA1 DB). Sync API 121 is further configured to send inventory information returned in response to the intermediate sync request to reporting tool 102.

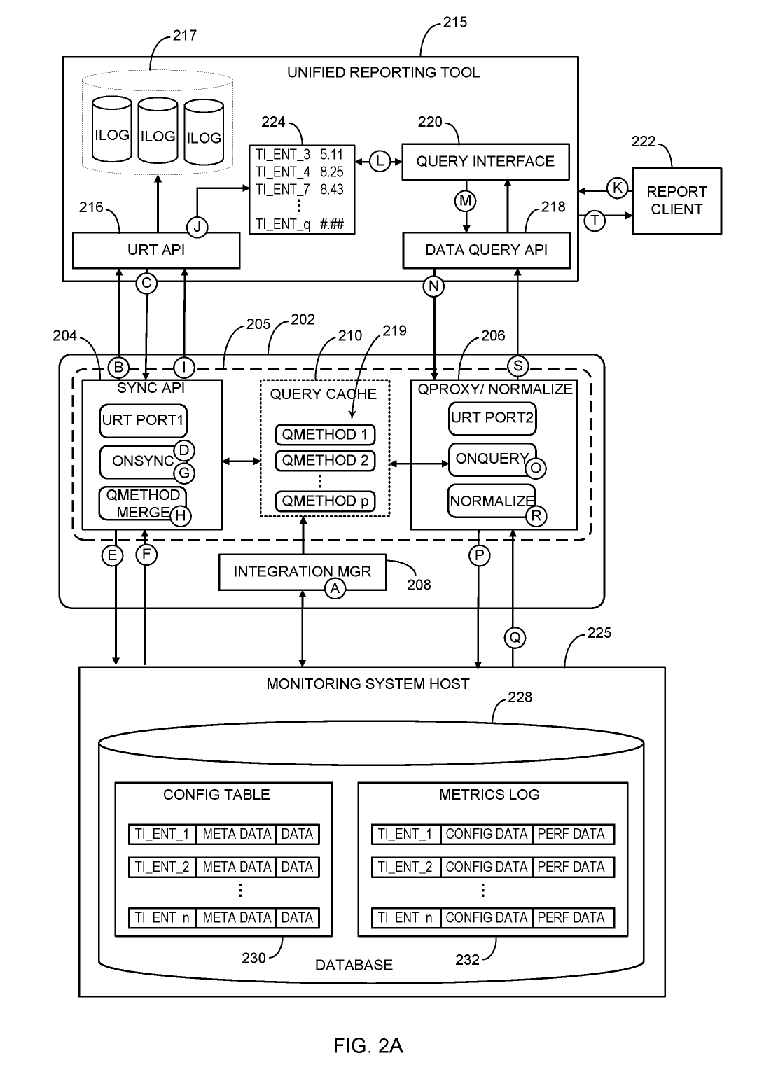

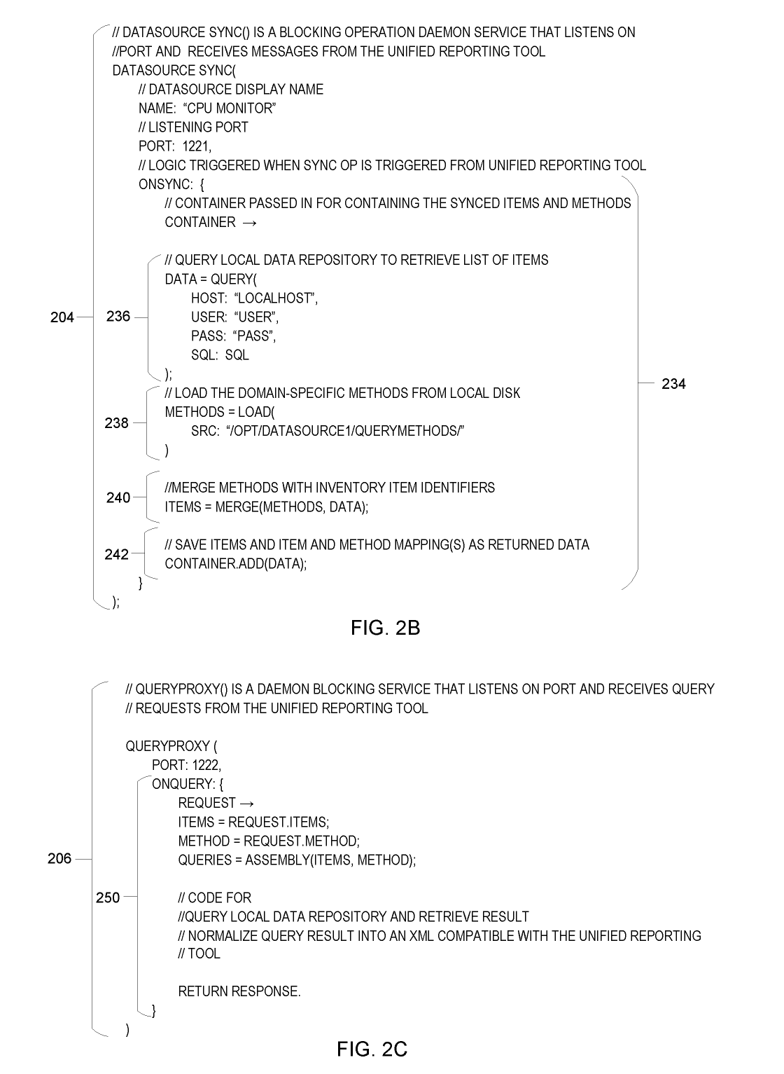

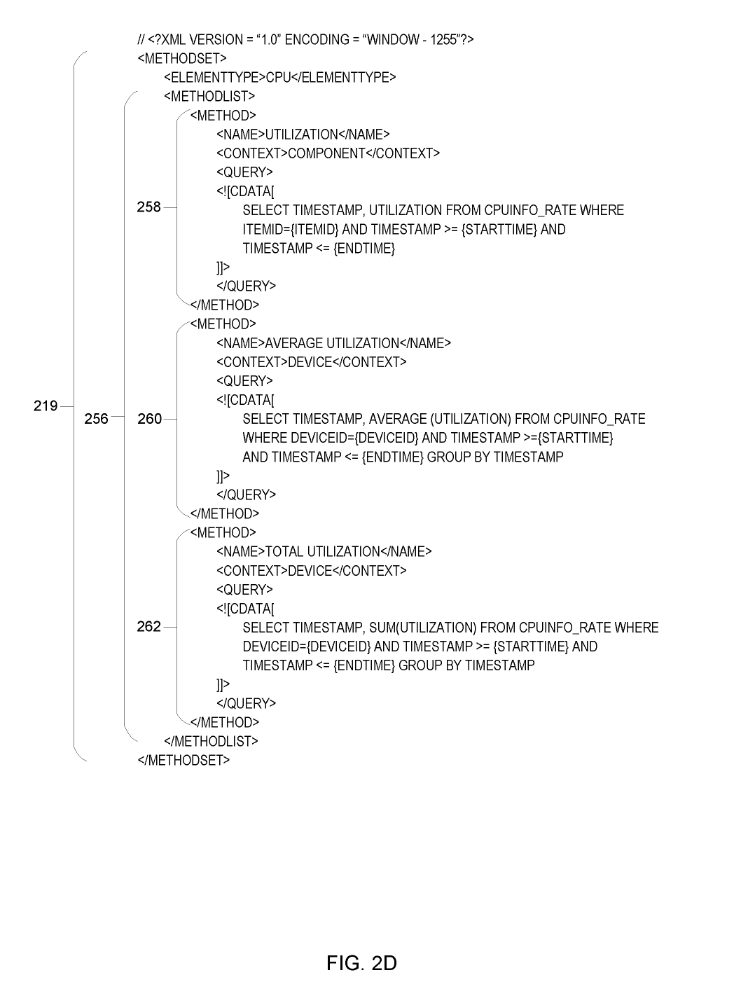

Each of the sync APIs within integration packs 116, 118, and 120 may be further configured to perform domain query processing preparation during and as part of sync operations. As explained in further detail with reference to FIGS. 2A-2D, 3, and 4, each sync API may be configured to collect query schema information associated with each of the inventory items that are identified in the inventory information that is returned to reporting tool 102. In some embodiments, the query schema information includes query method IDs for query methods that are associated with the respective inventory items.

Each query proxy and normalizer within integration packs 116, 118, and 120 is configured to mediate query operations initiated by reporting tool 102. For example, query proxy and normalizer 123 may include program instructions for translating or otherwise replacing a reporting tool query request that does not conform to the native query schema of data source 108 (e.g., query schema specified by SCHEMA1 DB). As explained in further detail with reference to FIGS. 2A-2D, 3, and 4, the query proxy function includes retrieving locally stored query methods that were stored by integration layer 115 during sync operations. The query proxy components identify the required query methods based on the inventory items specified by the query request from reporting tool 102. The identified query methods are included in the intermediate query request that is then sent to the respective data source for processing.

Integration manager 125 includes components for allocating and managing integration packs 116, 118, and 120. In some embodiments, the allocation and management role of integration manager 125 is performed over the life cycle of each of the integration packs from deployment through update, failover, and removal. For example, integration manager 125 may deploy/allocate two integration packs to discover and establish communication with the same data source. One of the integration packs is configured as the active integration pack and the other as the back up integration pack. In response to detecting the active pack is down, integration manager 125 transfers the workload to the stand by integration pack to maintain high availability

In the depicted embodiment, integration manager 125 includes an integration pack allocation unit 126 that is configured to allocate one or more integration packs to each of the data sources. In some embodiments, allocation unit 126 may collect operational metrics including inventory information related to sync and query operations to determine whether the integration pack allocation for a given data source should be adjusted based on operating conditions such as processing load. Integration manager 125 is further configured to receive inventory format and query schema information from each of data sources 108, 110, and 112. Integration manager 125 may be further configured to store the formatting and schema information in a schema table 128 that may be utilized by allocation unit 126 to configure or reconfigure the allocated integration packs to include the schema information. As shown, the first row-wise record of schema table is indexed by a data source ID, DS_1, and includes schema information (represented as SCHEMA1) for data source DS_1. In this manner, integration manager 125 can configure a newly allocated integration pack with the schema information native to the data source to which the new integration pack is to be allocated.

FIG. 2A is a block diagram illustrating an example data source integration system that includes subsystems, devices, and other components for implementing data source integration including multi-domain query processing in accordance with some embodiments. The components of the system depicted in FIG. 2A may be implemented in the source integration system depicted in FIG. 1. The system includes a unified source interface implemented as a reporting tool 215, an integration layer implemented by an integration server 202, and multiple data sources (only one expressly depicted) including a data source implemented as a database 228 within a monitoring system host 225. Reporting tool 215 is configured using any combination of hardware and software program constructs to facilitate communication and processing transactions between a report client 222 and database 228.

Reporting tool 215 includes a URT API 216 that, similar to URT API 104 in FIG. 1, comprises program components for transacting the front-end and back-end portions of a sync operation between reporting tool 215 and database 228. Reporting tool 215 further includes a data query API 218 that, similar to data query API 106 in FIG. 1, comprises program components for transacting the front-end and back-end portions of a query operation conducted between reporting tool 215 and database 228. A query interface 220 is communicatively coupled with data query API 218 and is configured using any combination of programmed hardware and program code to receive and process client requests such as from report client 222. Generally, query interface 220 is configured to pre-process a client request such as a query request using query method information obtained from a query method table 224 and forwarding the pre-processed query request to data query API 218 for further processing.

Integration server 202 provides a processing and storage platform on which integration packs, including an integration pack 205, execute in a manner substantially similar to the description of integration packs in FIG. 1. Integration pack 205 is configured using any combination of program logic constructs and data to implement mediated data source integration based in part on inventory item synchronization and on domain-based query processing. To implement the inventory item sync function, integration pack 205 includes a sync API 204 comprising a sync port daemon service, URT PORT1, a sync routine, ONSYNC, and a query method merge routine, QMETHOD MERGE.

Referring to FIG. 2B, a pseudo-code representation of some of the components within sync API 204 is depicted. Sync API 204 specifies the data source to which integration pack 205 is allocated as NAME: “CPU MONITOR,” which in the depicted embodiment is the assigned name of database 228. The FIG. 2B representation also depicts a sync port number assignment of PORT: 1221 as the sync port to be monitored by the URT PORT1 daemon service. The ONSYNC and QMETHOD MERGE routines are representationally depicted by ONSYNC 234, which comprises a sync query portion 236, a query method load section 238, a merge section 240, and a collective save section 242. The ONSYNC routine generally represented as 234, passes in an empty container, CONTAINER. Then the ONSYNC code execution passes to 236 and 240, which collects inventory information and query methods from the data source. The ONSYNC routine then loads the inventory information and query method information into the container as represented at collective same section 242. In some embodiments, backend logic (not expressly represented) within the integration framework that monitors the execution of the logic represented at 236 and 242 and, in response to detecting completion, retrieves the content from the CONTAINER. The backend logic then determines whether to push all of the content to the report center (full-sync) or only push changed items to the report center (incremental-sync).

Referring back to FIG. 2A, to implement the query request processing function, integration pack 205 includes a query proxy and normalize API 206 comprising a query port daemon service, URT PORT2, a query transform routine, ONQUERY, and a normalize routine, NORMALIZE. Referring to FIG. 2B, a pseudo-code representation of some of the components within query proxy and normalize API 206 is depicted. Query proxy and normalize API 206 includes a query port number assignment of PORT: 1222 as the query port to be monitored by the URT PORT2 daemon service. The ONQUERY and NORMALIZE routines are representationally depicted by ONQUERY 250, which specifies instructions for retrieving query methods conforming to the native query schema of database 228.

Also installed and executing within integration server 202 is an integration manager program 208 that receives configuration information including native formatting and query schema information for database 228 from monitoring system host 225. In some embodiments, integration manager 208 collects query schema information including specific query methods from monitoring system host 225 and stores these locally such as within an allocated query cache 210.

Monitoring system host 225 is a processing and storage platform configured using any combination of hardware and program code to collect data from monitoring components within a target infrastructure. The target infrastructure (not depicted) may comprise a set of hardware and/or software devices and components that are monitored by monitoring agents (not depicted) or otherwise to generate performance data corresponding to the infrastructure items that are being monitored. Monitoring system host 225 collects at least two categories of information/data associated with the overall monitoring function. Monitoring system 225 collects infrastructure information/data (alternately referred to as inventory information/data or inventory item information/data). Monitoring system host 225 stores the collected infrastructure information in a configuration table 230 within database 228. Within table 230, the infrastructure information is maintained in records indexed at least by a target entity ID entry and further including metadata and data fields. For example, the first row-wise record includes a target entity ID field/index containing the entity ID “TI_ENT_1.” Associated at least by virtue of presence in the same first record with the “TI_ENT_1” ID is a set of metadata in the metadata field and data in the data field. The data may include information describing the infrastructure entity itself, such as application or device model, type, etc.

The second category of information/data collected or otherwise received and stored by monitoring system 225 is performance data that is originally collected by the monitoring agents in association with operation of the infrastructure entities. Monitoring system host 225 stores the received performance data in a metrics log 232 within database 228. Within log 232, the performance data is maintained in records indexed at least by a target entity ID entry and further including configuration data and performance data fields. For example, the second row-wise record includes a target entity ID field/index containing the entity ID “TI_ENT_2.” Associated at least by virtue of presence in the same second record with the “TI_ENT_2” ID is a set of configuration data in the configuration data field and performance data in the performance data field. The performance data includes performance metrics associated within the records with respective timestamps.

FIG. 2A is annotated with a series of letters A-T. These letters represent stages of operations performed during one or more of a portion of a data source integration cycle and a domain-based query cycle. Although these stages are ordered for this example, the stages illustrate one example to aid in understanding this disclosure and should not be used to limit the claims. Subject matter falling within the scope of the claims can vary with respect to the order and some of the operations.

At stage A, integration manager 208 collects or otherwise receives from monitoring system host 225 query schema information regarding the native query schema utilized by database 228. In the depicted embodiment, the query schema information includes query methods included in the native query schema of database 228. Also at stage A, integration manager 208 stores the received query methods as a method set 219 within query cache 210. Referring to FIG. 2D, a pseudo-code representation (XML format) of method set 219 is depicted. As shown, method set 219 specifies an element type “CPU” that is associated with a method list 256 comprising query methods 258, 260, and 262. In this manner, the element type “CPU” is commonly associated with each of the query methods which may be mutually distinct in terms of specified method type and context. The method type is identified by the tagged NAME field and context by the tagged CONTEXT field. For method 258, the method type is UTILIZATION and the context is COMPONENT. In the depicted embodiment, the ELEMENTTYPE field entry in combination with the CONTEXT field entry determines which types of query methods are available. For method set 219, only the UTILIZATION type QUERY method is available for a request for CPU type under the COMPONENT context. Under the DEVICE context, both AVERAGE UTILIZATION and TOTAL UTILIZATION are available for the CPU element type.

Returning to FIG. 2A, at stage B sync API 204 registers database 228 and/or the monitoring system host 225 with reporting tool 215 by transacting a registration sequence with URT API 216. At stage C, reporting tool 215 issues a sync request via URT API 216 which is received and processed by sync API 204. More specifically, the sync request is detected by the URT PORT1 daemon on the sync port 1221. In response to the received sync request, the ONSYNC routine is triggered and executes program instructions to generate an intermediate sync request that utilizes the native inventory description format of database 228 (stage D).

The intermediate sync request is sent to monitoring system host 225 at stage E which responds by collecting the requested sync inventory item information and transmitting the information to sync API 204 at stage F. The ONSYNC routine executes instructions to determine, based on inventory ID information contained in the sync response, whether and which of the query methods stored within query cache 210 are associated with the corresponding inventory items (stage G). The query method IDs of the query methods determined to be associated are retrieved and at stage H, the QMETHOD MERGE routine instructions represented as merge section 240 in FIG. 2B are executed to merge the retrieved query method IDs with the inventory item information received from monitoring system host 225. As part of stage H, the merged query method IDs and inventory information are further processed by the collective save routine represented as section 242 in FIG. 2B to save the inventory item information and the mappings between inventory items and corresponding associated query method IDs in a container that was passed in by the ONSYNC routine and to be transmitted as the sync results to reporting tool 215 at stage I. URT API 216 stores the inventory information returned in response to the sync request within inventory logs 217. At stage J, URT API 216 executes program instructions to save the mappings of inventory items to respective query method IDs in query method table 224.

A domain query cycle begins at stage K with reporting client transmitting a performance data query request to be received and processed by query interface 220 within reporting tool 215. Query interface 220 instructions are executed to identify query method IDs stored within query method table 224 that are associated with inventory items, such as infrastructure entities in the depicted example, identified in the client query request (stage L). Query interface 220 retrieves the identified query method IDs and provides the IDs together with the client query request to data query API 218 at stage M. Data query API 218 transmits the query method IDs in association with the client query request as an intermediate query request to query proxy and normalize API 206 (stage N). The intermediate query request is detected on query port 1222 by URT PORT2 daemon service, and at stage O the ONQUERY routine generates a native query request based on the intermediate query request but conforming to the native query schema of database 228. To this end, and as part of stage O, the ONQUERY routine retrieves from query cache 210 query methods that correspond to the query method IDs included in the intermediate query request. The native query request is generated to include the retrieved query methods.

At stage P, query proxy and normalize API 206 transmits the native query request to monitoring system host 225 and database 228. Database 228 processes the query request and returns the results to query proxy and normalize API 206 at stage Q. At stage R, the normalize routine translates the query results into a format that is used by client platforms communicating with reporting tool 215. For example, the normalization may include converting the display format of the returned query results to a markup language format. Query proxy and normalize API 206 transmits the normalized query results to data query API 218 at stage S, and the results are forwarded by reporting tool 215 to report client at stage T.

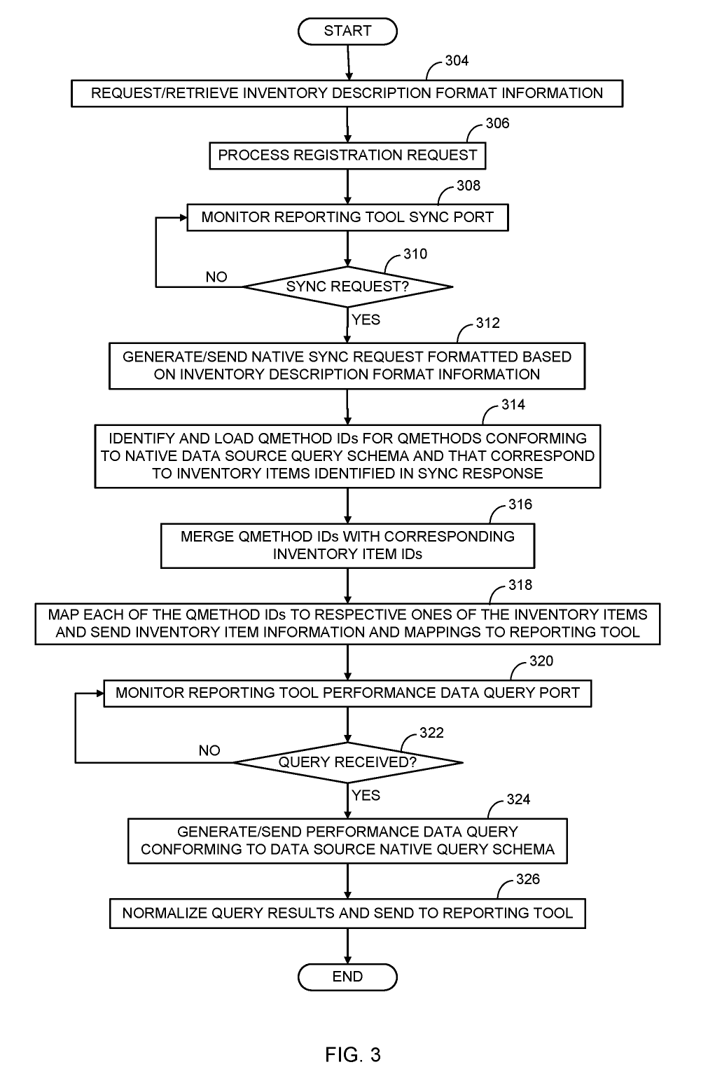

FIG. 3 is a flow diagram illustrating operations and functions for integrating data sources with a reporting tool in accordance with some embodiments. The operations and functions depicted in FIG. 3 may be performed by one or more of the systems, subsystems, devices, and components illustrated and described with reference to FIGS. 1 and 2A-2D. The process begins as shown at block 304 with an integration manager requesting and retrieving inventory description format information from one or more data sources that provide inventory information and performance data to a reporting tool. In some embodiments, the retrieved inventory description format information is utilized to configure a sync API within an integration pack to translate sync requests received directly from the reporting tool into intermediate sync requests conforming to the native inventory description format utilized by the data source to which the integration pack is allocated. At block 306, the reporting tool processes a registration request from an integration pack that has been or will be allocated to a particular one of the data sources.

Sync operation processing begins as shown at block 308 with a service daemon deployed by the sync API monitoring a sync port that is utilized by the reporting tool. A sync operation cycle begins as shown at blocks 310 and 312, with a sync request being received, and in response the sync API within the integration pack generates and sends a native sync request that is formatted in conformity with inventory description format information such as that retrieved at block 304. The data source returns a response including inventory information that identifies one or more inventory items (e.g., list of one or more CPU added to a target infrastructure). The sync API identifies locally stored query methods that conform to the native query schema of the data source and that correspond to inventory items identified or otherwise specified by the sync response information provided by the data source (block 314). The sync API loads query method IDs of the identified query methods and merges the IDs with corresponding inventory item information such as inventory item IDs (block 316). At block 318, the sync API maps each of the query method IDs to respective inventory item IDs and sends the inventory information returned in the sync response together with the mappings to the reporting tool.

Comain query processing begins as shown at block 320 with a query proxy and normalize API within the integration pack monitoring a query port utilized by the reporting tool. A query processing cycle begins as shown at blocks 322 and 324, with a performance data query request being received, and in response the query proxy and normalize API generating a native performance data query request that conforms to the native query schema of the data source. As shown at block 326, the response from the data source to the native query request is normalized and the normalized results transmitted to the reporting tool which can then provide the results to the requesting client.

FIG. 4 is a flow diagram depicting operations and functions for processing queries in a multi-domain source interface system in accordance with some embodiments. The operations and functions depicted in FIG. 4 may be performed by one or more of the systems, subsystems, devices, and components shown and described with reference to FIGS. 1, 2A-2D, and 3. The process begins as shown at block 402 with a reporting tool receiving a performance data query request from a client application. A reporting tool query interface processes the request including parsing the query content to identify or otherwise determine inventory item IDs (block 404).

In conjunction with the process of identifying inventory item IDs, the query interface processes each of the inventory item IDs beginning at block 406 and continuing to block 408 with the query interface accessing and indexing a table that stores mappings between inventory item IDs and query method IDs. The query interface utilizes the next-processed inventory item ID as an index into the mapping table entries to locate one or more corresponding query method IDs (blocks 408 and 410). In response to finding no matching table entry, control passes back to block 406 with processing of a next inventory item ID. Otherwise, in response to locating one or more table entries that map inventory item IDs matching inventory IDs included in the client query request, control passes to block 412 with the query interface retrieving the query method IDs mapped to the inventory item IDs. The inventory ID processing cycle continues until all inventory item IDs determined from the performance data request have been processed (block 414) and control passes to block 416.

At block 416, a data query API within the reporting tool generates and transmits an intermediate performance data query request that includes the query method IDs that were retrieved at occurrences of block 412. The intermediate query is received and processed by a query proxy and normalization API within an integration pack. At block 418, the query proxy and normalization API identifies and retrieves query methods from a query cache maintained by the integration pack. The API uses the query method IDs included in the intermediate query to locate the query methods themselves within the query cache.

At block 420, the query proxy and normalization API generates a native performance data query request using the query methods retrieved at block 418 and sends the request to the data source. In response to receiving the performance query results from the data source, the query proxy and normalization API normalizes the results and transmits the normalized results to the reporting tool (block 422). The process ends with the reporting tool returning the normalized results to the requesting client (block 424).

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

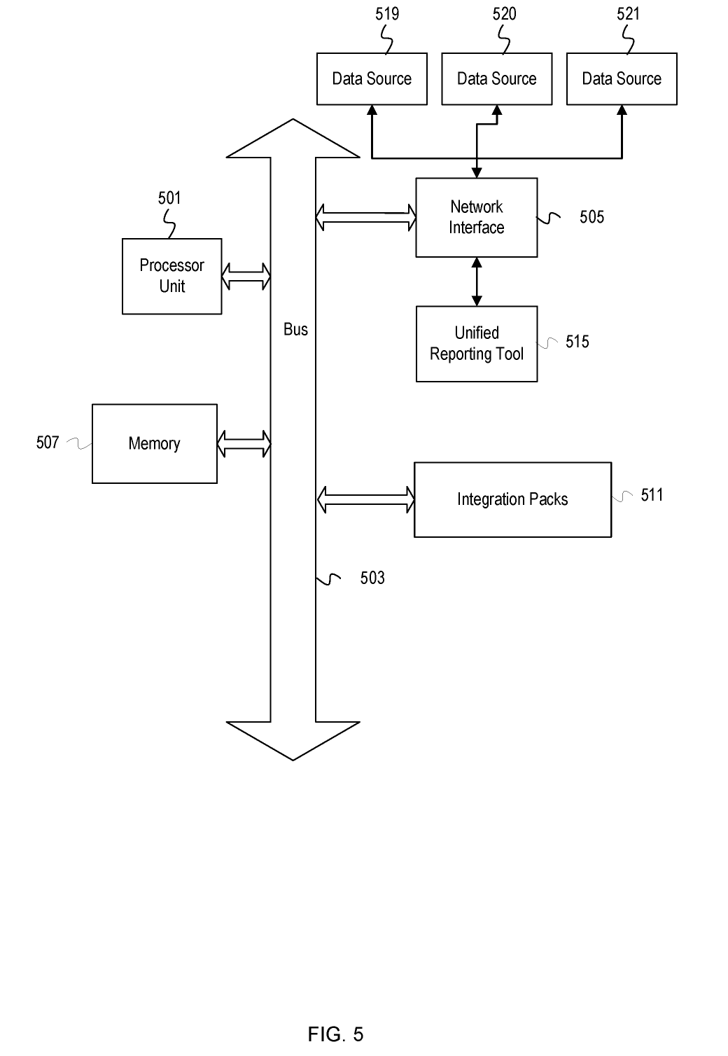

FIG. 5 depicts an example computer system that implements data source integration and domain query processing in accordance with some embodiments. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes an integration layer 511 such as may incorporate the systems, devices, and components depicted in FIGS. 1 and 2A-2D. The integration layer 511 provides program structures for integrating data sources with a source interface as described with reference to FIGS. 1-4. To this end, the integration layer 511 may incorporate and/or utilize some or all of the system, devices, components, and data structures described in FIGS. 1 and 2A-2D.

Communicatively coupled to the integration layer via network interface 505 are a reporting tool 515 and multiple data sources 519, 520, and 521.

Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for integrating data sources as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method for processing queries in a multi-domain source interface system, said method comprising:
in response to a first query request from a source interface tool for performance data stored in a data source,
retrieving one or more query methods that conform to a native query schema of the data source; and
generating and transmitting to the data source a second query request that includes the retrieved query methods; and
transmitting query results received in response to the second query request to the source interface tool.

2. The method of claim 1, wherein the first query request includes at least one query method identifier (ID), said retrieving one or more query methods comprising utilizing the at least one query method ID as an index to select the one or more query methods to be retrieved.

3. The method of claim 2, further comprising:
in response to receiving a third query request, identifying and retrieving the at least one query method ID based on one or more inventory items specified by the third query request; and
generating the first query request to include the retrieved at least one query method ID.

4. The method of claim 3, further comprising during a sync operation between the source interface tool and the data source, retrieving query method IDs including the at least one query method ID in association with inventory items included in the sync operation.

5. The method of claim 1, wherein the one or more query methods are maintained in a method list including a plurality of query methods maintained external to the data source, said method further comprising:
retrieving the plurality of query methods from the data source; and
generating the method list to include the retrieved query methods.

6. The method of claim 1, further comprising:
retrieving inventory information from the data source; and
determining one or more query methods that are associated with one or more inventory items identified in the retrieved inventory information.

7. The method of claim 6, further comprising:
transmitting query method IDs of the determined one or more query methods and the inventory information to the source interface tool; and
mapping each of the query method IDs to respective ones of items described in the inventory item description information.

8. One or more non-transitory machine-readable media comprising program code for processing queries in a multi-domain source interface system, the program code to:
in response to a first query request from a source interface tool for performance data stored in a data source,
retrieve one or more query methods that conform to a native query schema of the data source; and
generate and transmit to the data source a second query request that includes the retrieved query methods; and
transmit query results received in response to the second query request to the source interface tool.

9. The machine-readable media of claim 8, wherein the first query request includes at least one query method identifier (ID), wherein the program code to retrieve one or more query methods comprises program code to utilize the at least one query method ID as an index to select the one or more query methods to be retrieved.

10. The machine-readable media of claim 9, wherein the program code further includes program code to:
in response to receiving a third query request, identify and retrieve the at least one query method ID based on one or more inventory items specified by the third query request; and
generate the first query request to include the retrieved at least one query method ID.

11. The machine-readable media of claim 10, wherein the program code further includes program code to, during a sync operation between the source interface tool and the data source, retrieve query method IDs including the at least one query method ID in association with inventory items included in the sync operation.

12. The machine-readable media of claim 8, wherein the one or more query methods are maintained in a method list including a plurality of query methods maintained external to the data source, wherein the program code further includes program code to:
retrieve the plurality of query methods from the data source; and
generate the method list to include the retrieved query methods.

13. The machine-readable media of claim 8, wherein the program code further includes program code to:
retrieve inventory information from the data source; and
determine one or more query methods that are associated with one or more inventory items identified in the retrieved inventory information.

14. The machine-readable media of claim 13, wherein the program code further includes program code to:
transmit query method IDs of the determined one or more query methods and the inventory information to the source interface tool; and
map each of the query method IDs to respective ones of items described in the inventory item description information.

15. An apparatus comprising:
a processor; and
a machine-readable medium having program code executable by the processor to cause the apparatus to:
in response to a first query request from a source interface tool for performance data stored in a data source,
retrieve one or more query methods that conform to a native query schema of the data source; and
generate and transmit to the data source a second query request that includes the retrieved query methods; and
transmit query results received in response to the second query request to the source interface tool.

16. The machine-readable media of claim 15, wherein the first query request includes at least one query method identifier (ID), wherein the program code further includes program code executable by the processor to cause the apparatus to:
in response to receiving a third query request, identify and retrieve the at least one query method ID based on one or more inventory items specified by the third query request; and
generate the first query request to include the retrieved at least one query method ID.

17. The machine-readable media of claim 16, wherein the program code further includes program code executable by the processor to cause the apparatus to, during a sync operation between the source interface tool and the data source, retrieve query method IDs including the at least one query method ID in association with inventory items included in the sync operation.

18. The machine-readable media of claim 15, wherein the one or more query methods are maintained in a method list including a plurality of query methods maintained external to the data source, wherein the program code further includes program code executable by the processor to cause the apparatus to:
retrieve the plurality of query methods from the data source; and
generate the method list to include the retrieved query methods.

19. The machine-readable media of claim 15, wherein the program code further includes program code executable by the processor to cause the apparatus to:
retrieve inventory information from the data source; and
determine one or more query methods that are associated with one or more inventory items identified in the retrieved inventory information.

20. The machine-readable media of claim 19, wherein the program code further includes program code executable by the processor to cause the apparatus to:
transmit query method IDs of the determined one or more query methods and the inventory information to the source interface tool; and
map each of the query method IDs to respective ones of items described in the inventory item description information.
